(19) United States
(12) Patent Application Publication
(10) Pub. No.: US 2007/0181528 A1
(43) Pub. Date: Aug. 9, 2007

(54) Method of etching treatment

(76) Inventors: Kunihiko Koroyasu, Kudamatsu-shi (JP); Nobuyuki Negishi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/369,134

(22) Filed: Mar. 7, 2006

(30) Foreign Application Priority Data
Feb. 7, 2006 (JP) 2006-029411

(51) Int. Cl. G01L 21/30; C23F 1/00

(52) U.S. Cl. 216/59; 156/345.27; 156/345.48; 216/67

(57) ABSTRACT

The formation and adhesion of excessive deposits are suppressed in an etching process in which a resist of the ArF lithography generation and later is used as a mask. In an etching treatment method which is performed, by use of an etching apparatus which has a vacuum chamber 101, means for setting a sample to be worked 102 which sets a sample to be worked 107, cooling gas introducing means 111, a high frequency power source 106, a matching device 105, power introducing means 104, and a high frequency bias power source 110, by converting a gas introduced into the vacuum chamber 101 into a plasma and applying high frequency bias power to the sample to be worked 107, whereby surface treatment of the sample to be worked 107 is performed by the plasma, in treating the sample to be worked 107 by use of a highly depositable gas, the temperature of the sample to be worked 107 at the start of the treatment is maintained at a desired level.

The present application is based on and claims priority of Japanese patent application No. 2006-029411 filed on Feb. 7, 2006, the entire contents of which are hereby incorporated by reference.

### BACKGROUND OF THE INVENTION

1. Field of the Invention

The present invention relates to an etching method used in the etching of an interlayer dielectric film in the etching process and, more particularly, to a method which can improve worked shapes by suppressing deposits which impede etching in via formation, the formation of high aspect ratio contacts, the formation of self-aligning contacts, trench formation, damascene formation, gate mask formation and the like which are performed by use of a resist pattern after ArF lithography.

2. Description of the Related Art

In the manufacture of a semiconductor device, in order to electrically connect a transistor formed on a wafer and metal wires together and also the metal wires mutually, contact holes are formed between an upper part of a transistor structure and wires by a dry etching method which uses a plasma, and a semiconductor or metal is filled in the contact holes. Particularly, in the manufacture of a high integration, high speed logic device since the development of the 90 nm node technology, there are used the damascene process which involves forming trenches and vias by the dry etching method in an interlayer dielectric layer, which is a low-k material having a low permittivity, and burying Cu as a wiring material and the ArF lithography process which involves using a 193 nm light source to form finer patterns. The dry etching method is a technology which is such that an etching gas introduced into a vacuum chamber is converted into a plasma by high frequency power applied from the outside and reactive radicals and ions generated in the plasma are caused to react on a wafer with high accuracy, whereby a film to be processed is selectively etched in a mask material represented by a resist and in an interconnection layer under via holes and contact holes and a front-end substrate.

Usually, in the formation of an interconnection pattern of a semiconductor circuit, an organic film based bottom anti-reflection coating (BARC) is formed on a film to be processed and a resist film is further formed on the BARC. The BARC layer is formed to prevent the formation of an abnormal pattern due to the interference of a laser beam which is a light source of lithography. After the formation of a resist pattern, BARC etching is performed and after that, the etching of a film to be processed (main etching) is performed. In the BARC etching, a mixed gas composed of an F-rich fluorocarbon gas, such as CF₄ and CHF₃, a noble gas represented by Ar and oxygen gas is introduced because of a C-rich material for BARC as with a resist, a plasma is formed in the pressure region of 0.5 Pa to 50 Pa, and etching is performed by controlling the ion energy which is inputted into a wafer in the range of 0.1 kV to 5.0 kV.

In the formation of vias and contact holes, a mixed gas composed of a fluorocarbon gas, such as CF₄, CHF₃, CH₂F₂, CH₃F, C₂F₆, C₃F₆O, C₄F₈, C₅F₈ and C₄F₆, a noble gas represented by Ar, oxygen gas and CO gas, is introduced as a plasma gas, a plasma is formed in the pressure region of 0.5 Pa to 50 Pa, and the ion energy which is inputted into a wafer is accelerated from 0.1 kV to 5.0 kV.

In these etching methods, after the ignition of a plasma, bias power has hitherto been applied to the wafer when the plasma sufficiently comes into an equilibrium state. If bias power is applied to a wafer when a plasma has not sufficiently came into an equilibrium state or when the plasma has not ignited under some plasma conditions, the current which flows into the wafer cannot be sufficiently ensured or a current does not flow at all, with the result that an abnormally high voltage is applied to a bias power supply line, an electrode on which the wafer is set or the wafer itself. This may cause a dielectric breakdown of the bias power supply line, a breakage of a thermally sprayed film on the electrode or a cracking of the wafer. Therefore, from the standpoint of mass production, it has hitherto been general practice to provide means for detecting the ignition of a plasma (a luminescence intensity monitor) and to apply wafer bias power after a lapse of a certain time (an adjusted electric discharge period) after the detection of an ignition. Also, for gas conditions (gas type, gas flow rate) and the pressure of a back side gas (cooling gas) for wafer cooling, it has been general practice to perform treatment basically under the same conditions from the start of etching to the end of etching.

As plasma etching methods, there have been proposed methods which involve independently performing plasma generation and bias application to samples in order to change etching shapes, converting a mixed gas composed of an etching gas and a shape controlling gas into a plasma by electric discharge, and adjusting high frequency power for bias application without stopping the electric discharge during the etching of the samples by the plasma, whereby the energy which acts during the etching of the samples by the plasma is changed (refer to the Japanese Patent Publication No. 2695822, for example).

In such an etching process, the formation and adhesion of excessive deposits can cause a decrease in etching rate, a stop of etching, the occurrence of residues and the like.

In a KrF resist (an KrF excimer laser exposure resist), its etching resistance is sufficiently high compared to an ArF resist (an ArF excimer laser exposure resist) and the packing density of devices was not very high. Therefore, in pattern formation, excessive deposits did not pose a great problem. However, particularly, in via etching, trench etching and the like for a low-k material (an SiOC film) which is an interlayer dielectric film during dual damascene formation, etching residues caused by excessive deposits, dimensional changes by the lengthening of required treatment time and the like have a great effect on whether pattern formation is successfully performed.

Therefore, the present invention has as its object the provision of an etching method which suppresses the formation and adhesion of excessive deposits in an etching process in which a resist of the ArF lithography generation and later is used as a mask.

### SUMMARY OF THE INVENTION

In the present invention, by using either of the following means, carbon deposits on a wafer in the initial stage of etching treatment are reduced from conventional levels and the etching resistance of a resist is ensured.

In the first means, in performing etching under multiple treatment conditions, after the end of the treatment under a preceding condition and at the start of an electric discharge for plasma generation under a succeeding condition, the treatment is performed by making a transition from the preceding condition, with an electric discharge for plasma generation continued, without an interruption of the electric discharge for plasma generation, whereby deposits which would be formed during an adjusted electric discharge upon restart of an electric discharge after an interruption of the electric discharge for plasma generation are eliminated so solve the above-described problems.

In the second means, by adjusting the temperature of a sample to be treated at the start of the treatment, the adhesion of products by an electric discharge for plasma generation is suppressed to solve the above-described problems.

### BRIEF DESCRIPTION OF THE DRAWINGS

FIG. 1 is a sectional view to explain the rough configuration of an apparatus for UHF wave plasma etching treatment to which a method of etching treatment of the present invention is applied;

FIG. 2A is a diagram to explain the effect of electric discharge continuation treatment for plasma generation (a conventional method);

FIG. 2B is a diagram to explain the effect of electric discharge continuation treatment for plasma generation (a method of Embodiment 1);

FIG. 3 is a schematic sectional view to explain the via pattern generation process in a dual damascene structure using a low-k material;

FIG. 4A is a diagram to explain the shape improvement effect of the electric discharge continuation treatment in the treatment of a via pattern in a dual damascene structure using a low-k material (a conventional method);

FIG. 4B is a diagram to explain the shape improvement effect of the electric discharge continuation treatment in the treatment of a via pattern in a dual damascene structure using a low-k material (a method of Embodiment 2);

FIG. 5A is a diagram to explain changes in wafer temperature caused by cooling gas adjustment (a conventional method);

FIG. 5B is a diagram to explain changes in wafer temperature caused by cooling gas adjustment (a method of Embodiment 3);

FIG. 5C is a diagram to explain changes in wafer temperature caused by cooling gas adjustment (a method in which Embodiment 2 and Embodiment 3 are used in combination);

FIG. 6A is a diagram to explain the effect of the preliminary heating of a wafer (a conventional method);

FIG. 6B is a diagram to explain the effect of the preliminary heating of a wafer (a method of Embodiment 4);

FIG. 7A is a diagram to explain the effect of the combined use of the preliminary heating of a wafer and cooling gas adjustment (a conventional method); and

FIG. 7B is a diagram to explain the effect of the combined use of the preliminary heating of a wafer and cooling gas adjustment (a method of Embodiment 5).

### DETAILED DESCRIPTION OF THE PREFERRED EMBODIMENTS

The first embodiment of the present invention resides in that in performing etching under multiple treatment conditions, in making a transition to another condition after the end of a condition, this transition to a succeeding treatment condition is immediately made, with an electric discharge for plasma generation continued, without an interruption of the electric discharge for plasma generation, and bias power necessary for accelerating ions is applied.

Usually, in making a transition of conditions, if a bias is applied when the growth of a plasma is insufficient, a current which flows into a wafer cannot be sufficiently ensured, and an abnormally high voltage compared to a normal state is applied to a bias power transmission line, an electrode and the wafer itself. Therefore, this may cause a dielectric breakdown of each part and a cracking of the wafer. For this reason, it is necessary to have an adjustment period in which after the interruption of the electric discharge for plasma generation, re-ignition occurs and the plasma becomes stabilized. However, ions and radicals formed during this period deposit.

By continuing the electric discharge for plasma generation during a transition of conditions, it is possible to maintain the condition of a plasma which has grown sufficiently and hence the formation of deposits during the plasma adjustment time can be avoided.

The second embodiment of the present invention resides in that at the start of the etching treatment, a step which uses a cooling gas pressure lower than a cooling gas pressure supplied to a back surface of a wafer under actual etching conditions is introduced. This enables the wafer temperature in the initial period of the etching treatment to be raised to a high level. Usually, in controlling the wafer temperature, a coolant such as Flourinert is caused to flow in the interior of an electrode on which the wafer is set and helium gas (a cooling gas) having a high thermal conductivity is filled in between the wafer and the electrode to thereby improve thermal contact. In a case where the coolant temperature is controlled to a certain set value and bias power is applied to the wafer, the wafer temperature is uniquely determined by the pressure of helium gas (a cooling gas) to the back surface and the wafer temperature can be raised by the step which uses a cooling gas pressure lower than a cooling gas pressure supplied to a back surface of a wafer under actual etching conditions, with the result that it is possible to suppress the formation of deposits on the wafer at the start of the etching treatment.

The third embodiment of the present invention resides in that before the start of the etching treatment, a wafer is heated by a heater provided in the interior of an electrode. This enables the wafer temperature in the initial period of the etching treatment to be raised to a high level and hence the formation of deposits on the wafer at the start of the etching treatment can be suppressed.

### Embodiment 1

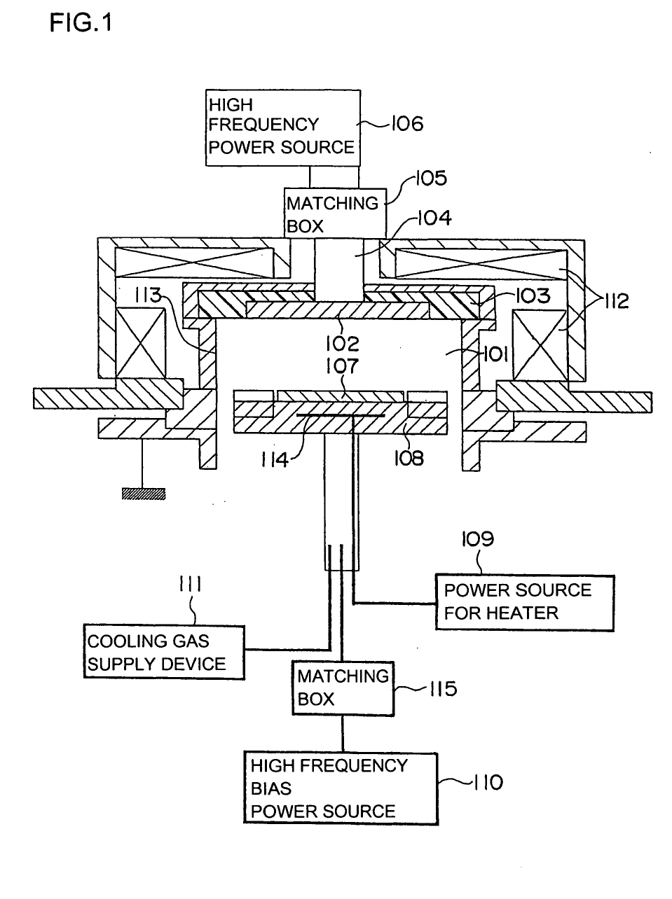

First, a description will be given of the first embodiment, which is such that in making a transition of etching treatment conditions in a case where two or more steps are used, this transition to an electric discharge condition for plasma generation of a succeeding treatment is immediately made, without an interruption of the electric discharge for plasma generation, and bias power for the succeeding treatment is applied, whereby the adhesion and formation of excessive deposits are avoided. FIG. 1 is a schematic diagram to explain an etching apparatus for realizing the first embodiment. Here is shown a UHF-ECR plasma etching apparatus which emits a UHF electromagnetic wave to the interior of an etching treatment chamber 101 from an antenna 102 and generates a plasma by an interaction with a magnetic field. This plasma treatment apparatus is constituted by the etching treatment chamber 101, the antenna 102, a dielectric material body 103, a wave guide 104, a matching box 105, a high frequency power source 106, a lower electrode 108 is provided with a heater 114 therein, a magnetic field coil 112, a power source for heater 109, a high frequency bias power source 110, a matching box 115, and a cooling gas supply device 111.

The temperature of an inner wall surface 113 of the etching treatment chamber 101 can be adjusted in the temperature range of 20 to 100° C. by use of temperature adjusting means which is not shown. The antenna 102 is disposed in an upper part of the etching treatment chamber 101, and the dielectric material body 103 through which a UHF electromagnetic wave can be transmitted is provided between the etching treatment chamber 101 and the antenna 102. In this case, the high frequency power source 106 which generates UHF electromagnetic waves is connected to the antenna 102 via the wave guide 104 and the matching box 105. The magnetic field coil 112 for forming a magnetic field within the etching treatment chamber 101 is wound around a peripheral portion of the etching treatment chamber 101. Below the antenna 102 within the etching treatment chamber 101, the lower electrode 108 is disposed as a sample bed on which a wafer 107 is to be placed. The high frequency bias power source 110 for giving the incident energy inputted into the wafer 107 to ions of a plasma is connected to the lower electrode 108 via the matching box 115, and a cooling gas is introduced from a cooling gas supplying device 111 to a back surface of the wafer. Furthermore, the heater 114 for heating the wafer on the lower electrode 108 is built in the electrode, and power from the power source for heater 109 is supplied to the lower electrode.

In the etching apparatus constructed as described above, a UHF electromagnetic wave outputted from the high frequency power source 106 is supplied from the antenna 102 portion to the etching treatment chamber 101 via the matching box 105, the wave guide 104 and the dielectric material body 103. On the other hand, a magnetic field by the magnetic field coil 112 around the etching treatment chamber 101 is formed in the etching treatment chamber 101, and due to the interaction of the electric field of the UHF electromagnetic wave and the magnetic field of the magnetic field coil 112, the etching gas introduced into the etching treatment chamber 101 is converted into a plasma, bias voltage is applied to the wafer 107 by the high frequency bias power source 110 via the matching box 115, and ions in the plasma are emitted to the wafer 107, whereby etching proceeds.

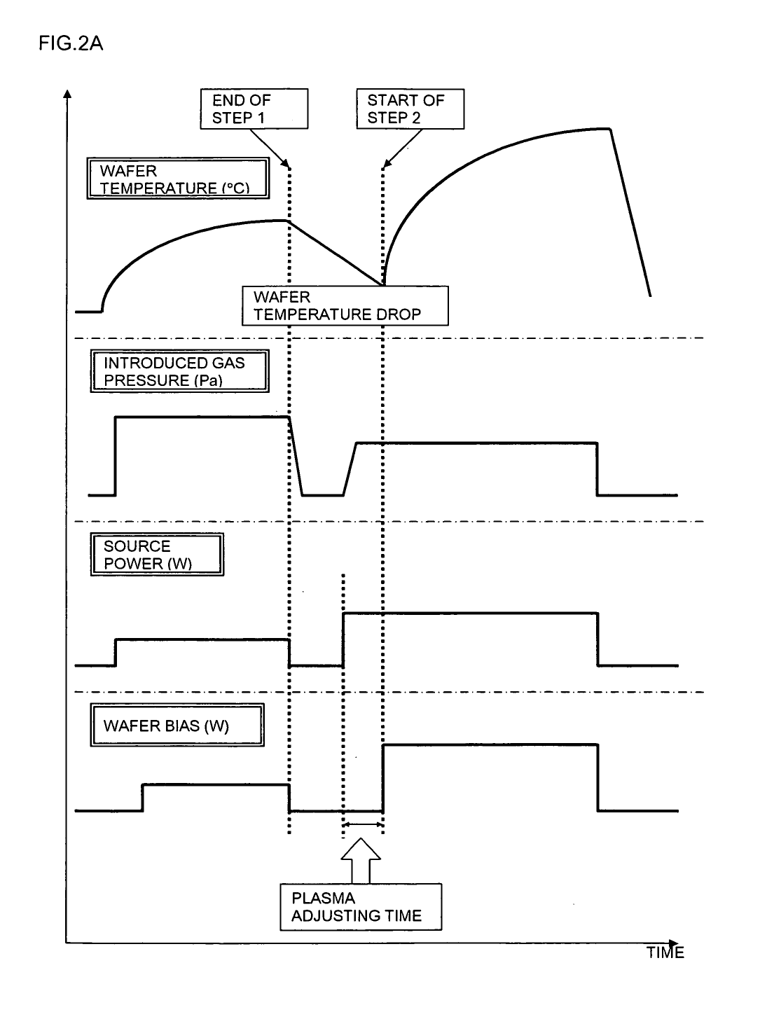

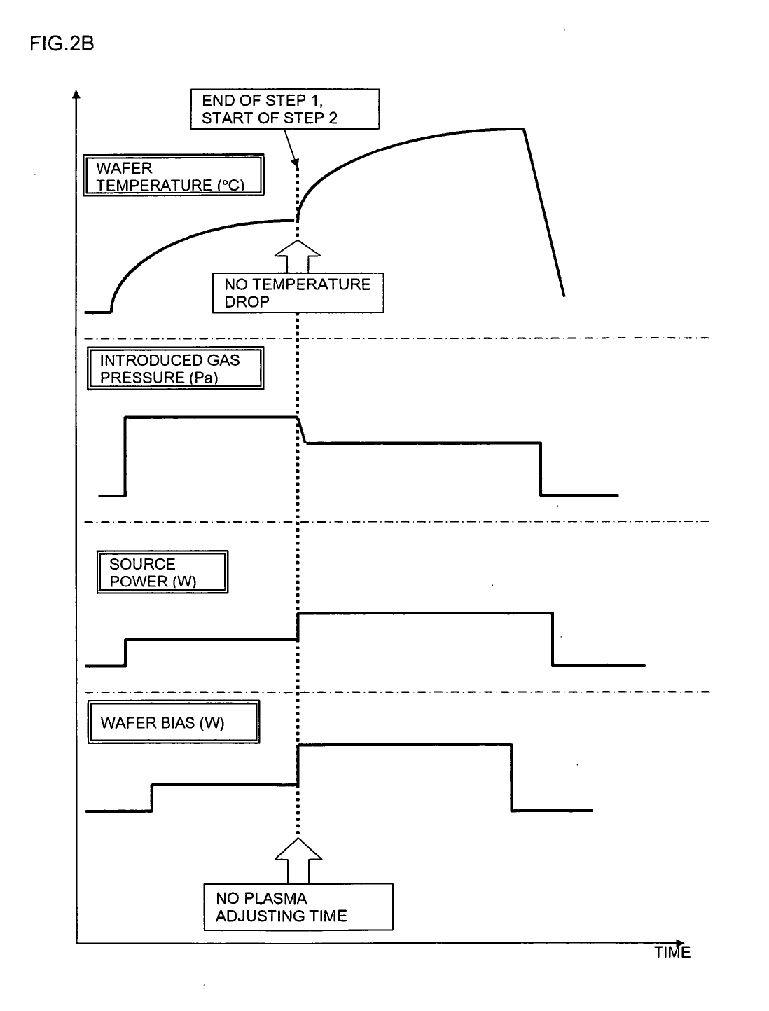

The relationships among wafer temperature, pressure of introduced gas (etching gas) for plasma generation, source power during an electric discharge for plasma generation, wafer bias power and time are shown in FIGS. 2A and 2B, FIG. 2A showing a case where an electric discharge for plasma generation is interrupted in making a transition of treatment conditions and FIG. 2B showing a case where a transition of treatment conditions is made without an interruption of an electric discharge for plasma generation.

As shown in FIG. 2A, under a conventional method, after the end of the first condition (the end of Step 1), the source power and wafer bias power are stopped and the pressure of an introduced gas for plasma generation is lowered, and after that, the source power of the second condition is applied and the pressure of an introduced gas for plasma generation of the second condition is raised, whereby an electric charge for plasma generation is started. When after the stabilization of the plasma, wafer bias power is applied under the second condition (the start of Step 2), an adjustment time for several seconds is necessary before the plasma under the changed condition comes into a stable condition. Ions and radicals generated during this period continue to deposit on a resist mask of the wafer because the wafer temperature has not sufficiently risen and because bias power has not been applied to the wafer, and this is the main cause of the hindrance of etching.

However, as shown in FIG. 2B, after the end of the first condition (the end of Step 1), a transition is made for the pressure of an introduced gas for plasma generation to the second condition without a stop of an electric charge for plasma generation, a transition is made for the source power to the second condition, and a transition is made for the wafer bias power to the second condition, whereby the wafer temperature adapts to the second conditions without a drop. Therefore, the deposition of ions and radicals on the wafer under the second condition can be prevented and hence it is possible to maintain going-through properties during etching. Furthermore, because bias is applied immediately after a transition of an electric discharge under the first condition to an electric discharge under the second condition, the deposition of ions and radicals on the wafer under the second condition can be prevented and hence it is possible to maintain going-through properties during etching.

That is, in the case where an electric discharge is interrupted, the wafer temperature drops for the duration in which bias is not applied and it takes time before the saturated temperature is reached again, whereas in the case where an electric discharge is continued, the saturated temperature is rapidly reached because the time is shortened, with the result that the adhesion of products can be suppressed.

Also, in making a transition of conditions, at the same time with the transition of the conditions, the matching box is adjusted to a matching position in which an electric discharge becomes stabilized under a changed condition which has been determined beforehand. Therefore, it is possible to rapidly stabilize an electric discharge while omitting the electric discharge adjusting time.

### Embodiment 2

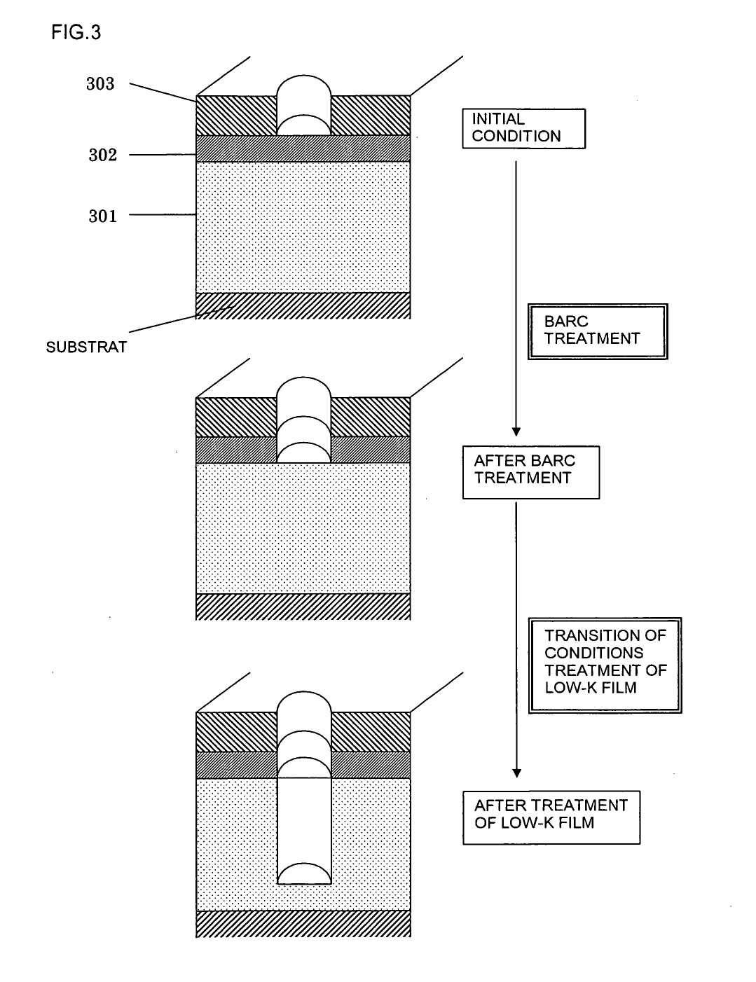

With reference to FIG. 3, a description will be given of the second embodiment, which is such that in performing the treatment of a workpiece under multiple treatment conditions by use of a method of performing the treatment without an interruption of an electric discharge for plasma generation between the treatment conditions, a via pattern in a dual damascene structure using a low-k material is formed.

FIG. 3 shows a schematic representation of the section of a via pattern in a dual damascene structure using a low-k material and its treatment process.

Upon a low-k film 301 of SiOC or the like, which is formed on a substrate, there is a BARC layer 302 provided with a TEOS film in its under layer. This BARC layer 302 serves as an antireflection coating when a resist pattern is exposed, and a photoresist film 303 exposed to a desired pattern is present on the BARC layer 302.

In forming a via pattern by treating such a sample, the BARC layer 302 is first treated under a condition and the low-k film 301 is then treated under another condition, whereby the via pattern is formed.

There has hitherto been practice to interrupt an electric discharge for plasma generation after the treatment of the first BARC layer 302, to re-ignite an electric discharge for plasma generation under the condition under which the low-k film layer 301 is treated, to stabilize the electric discharge for the duration of the electric discharge adjusting time which follows the re-ignition, and then to apply bias power to the sample to be worked, thereby to start the treatment. However, for the duration of the electric discharge adjusting time, products generated by the plasma adhere to the photoresist film and deposit without being sputtered because bias power is not applied.

If the treatment of the low-k film 301 is performed in this state, the products adhere also to side walls of pores of the photoresist film 303 and the openings of the pores are irregularly deformed, thereby exerting effect on the shape of the low-k film layer 301.

For example, by continuing an electric discharge for plasma generation in making a transition from the treatment condition for the BARC layer under which CF₄ is used as an etching gas (the first treatment condition) to the treatment condition for the low-k film layer under which a strongly depositable gas, such as CHF₃, C₄F₈ and H₂, is used (the second treatment condition), it becomes possible to suppress the deposition on the photoresist of the wafer and to obtain a desired shape.

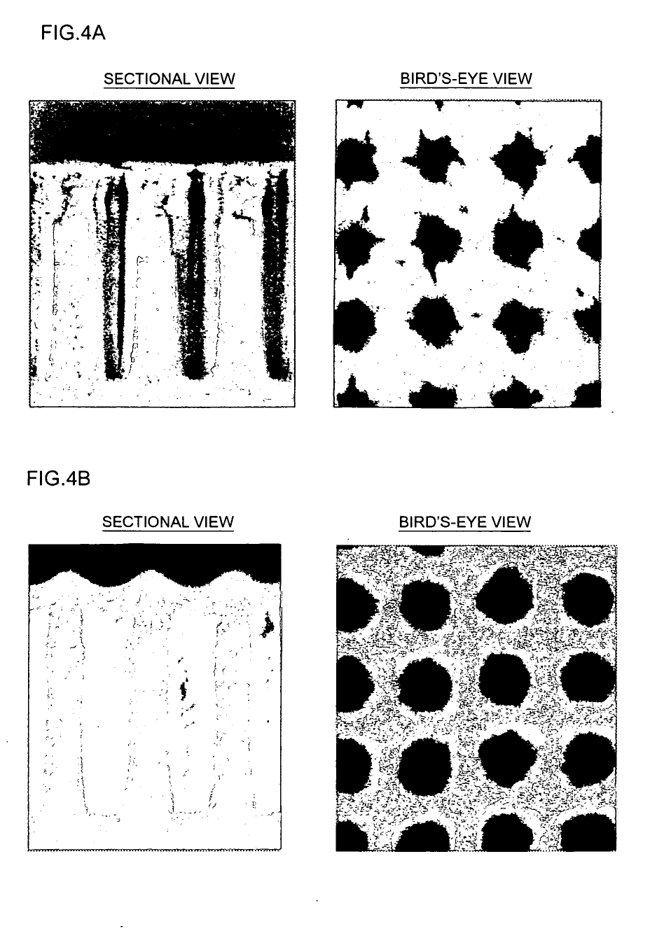

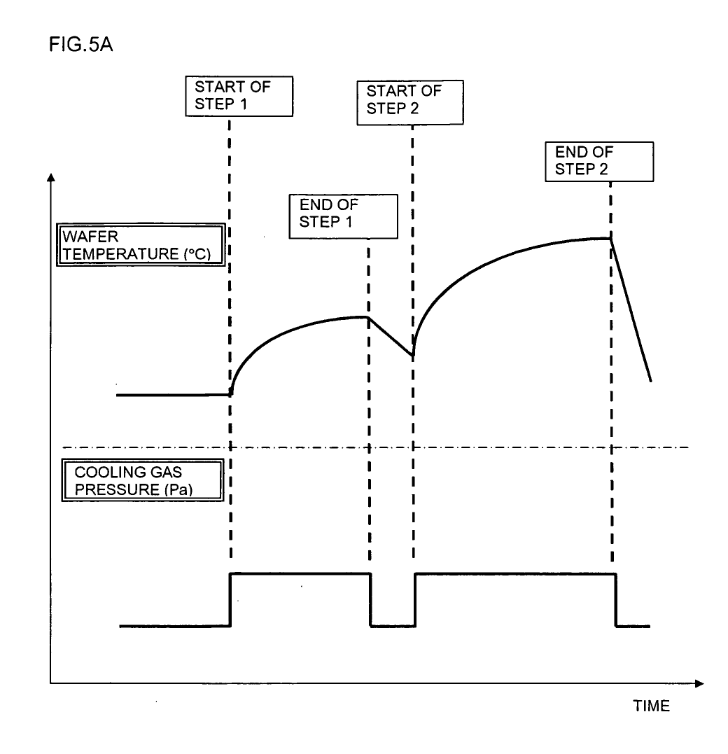

FIG. 4A shows the section of a via pattern in a case where an electric discharge for plasma generation is interrupted after the BARC layer treatment and the SiOC film layer, which is a low-k material, is there after treated, and a SEM photograph of this via pattern taken from above. In this treatment method, there are multiple fine streaks on a side wall of a pore (a via hole) formed in the SiOC film layer and the shape of openings is also irregular.

FIG. 4B shows a photograph in a case where a transition to the SiCO treatment condition is made, with an electric discharge for plasma formation continued after the BARC layer treatment, and the treatment is performed in this state. A side wall of a formed pore is smooth compared to the shape of the side wall of the conventional pore, and openings have a smooth circular shape.

### Embodiment 3

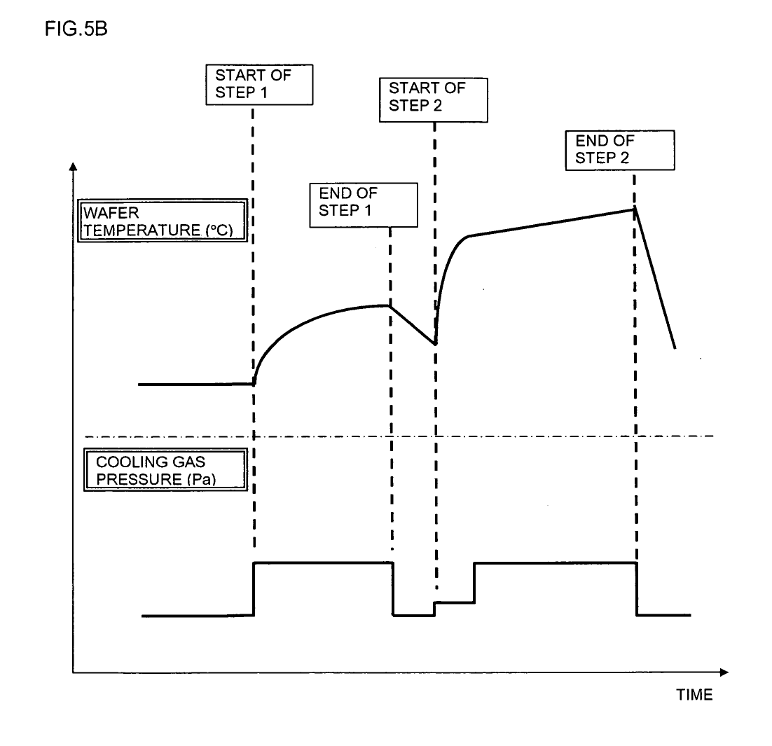

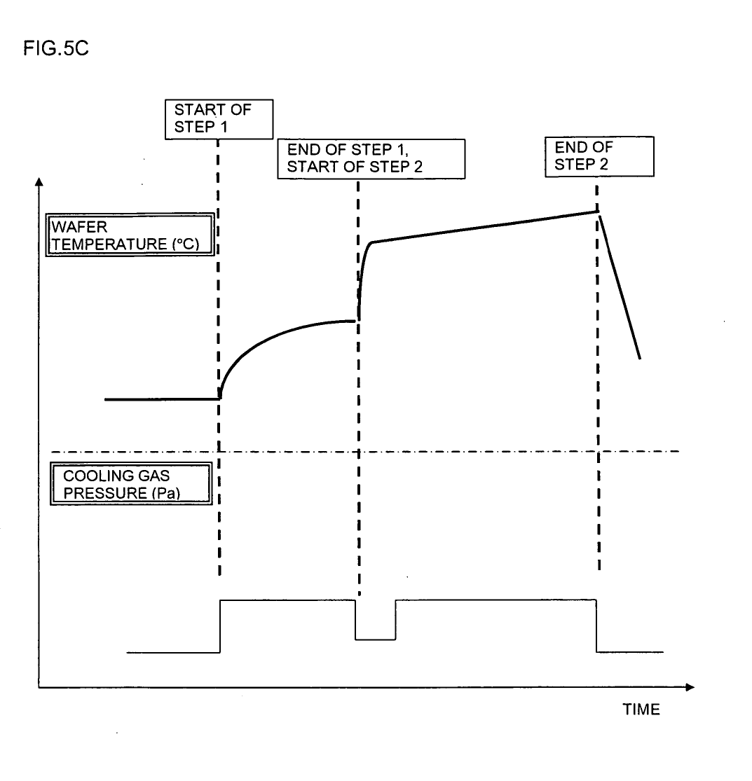

Next, a description will be given of Embodiment 3, which is such that in a case where a sample to be worked is treated by Step 1 which involves using a weakly depositable gas and by Step 2 which involves using a strongly depositable gas, the wafer temperature is controlled by adjusting the cooling gas at the start of the treatment. The relationships among wafer temperature, introduced cooling gas pressure and time after the application of bias power are shown in FIGS. 5A and 5B. FIG. 5A shows a case where the introduced cooling gas pressure is kept constant also at the start of the treatment of Step 2, and FIG. 5B shows a case where the introduced cooling gas pressure is lowered at the start of the treatment of Step 2.

In FIG. 5A, it takes time for the wafer temperature to come into a stationary state after the start of Step 2 and, therefore, excessive deposition occurs until the temperature becomes saturated. In contrast to this, in FIG. 5B, due to the lowering of the introduced cooling gas pressure to a back surface of a wafer, the wafer temperature rises steeply and the wafer after the start of the treatment of Step 2 obtains a temperature rise in a short time to such a level that deposits are not formed, with the result that the deposition on the wafer is suppressed.

A case where Embodiment 3 and Embodiment 2 are used in combination is shown in FIG. 5C. The temperature drop of a wafer during the transition of conditions can be prevented by making a transition to Step 2 immediately after the end of the treatment of Step 1, with an electric discharge for plasma generation continued. Furthermore, by lowering the cooling gas pressure at the start of the treatment of Step 2, the wafer temperature reaches a level at which deposits are not formed in a short time, and it becomes possible to shorten the time from the start of the treatment of Step 2 until the wafer temperature comes into a stationary state, with the result that the formation of deposits can be suppressed.

### Embodiment 4

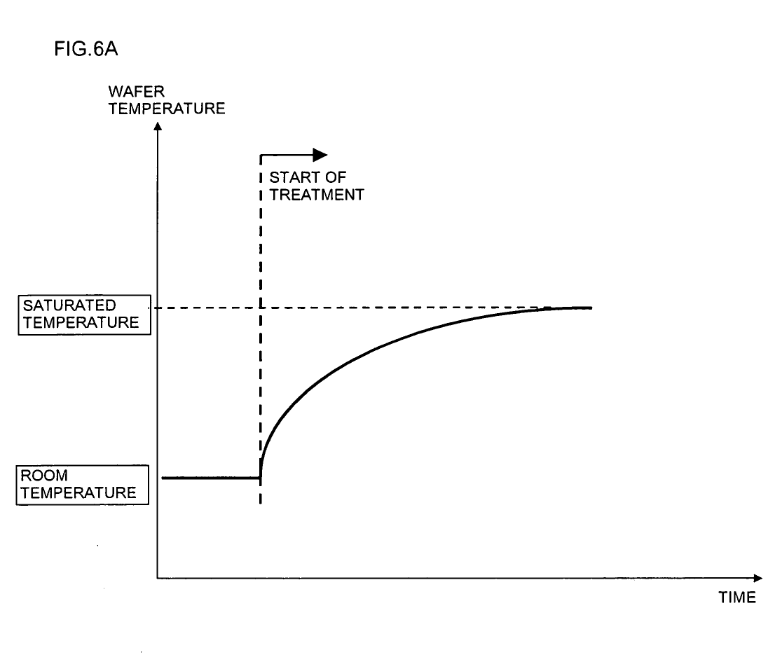

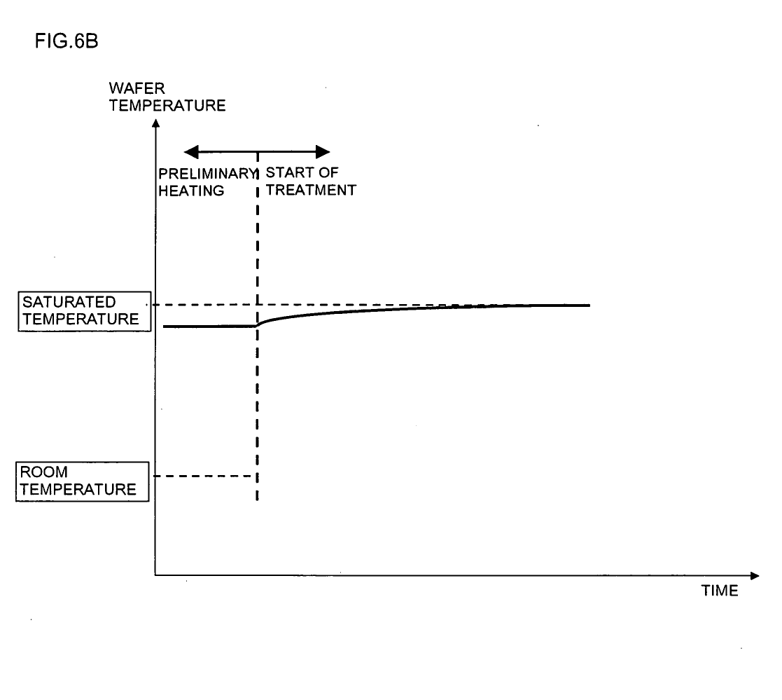

With reference to FIG. 6, a description will be given of Embodiment 4, which is such that by performing preliminary heating of a wafer before the start of the treatment, temperature changes of the wafer after the start of the treatment are eliminated and excessive deposition is suppressed.

The relationships between the temperature of a wafer on an electrode and time are shown in FIGS. 6A and 6B. FIG. 6A shows a case where the treatment is started immediately after the setting of the wafer on the lower electrode without performing preliminary heating by use of the heater 114. FIG. 6B shows a case where after the setting of the wafer on the electrode, heating is performed by use of the heater 114 until the wafer temperature reaches a level close to a saturated temperature during the treatment.

In FIG. 6A, it takes time for the wafer temperature to come into a stationary state immediately after the start of the treatment and, therefore, excessive deposition occurs during this low temperature condition. In contrast to this, in FIG. 6B, the wafer is in a high temperature condition already at the start of the treatment and the deposition can be suppressed.

### Embodiment 5

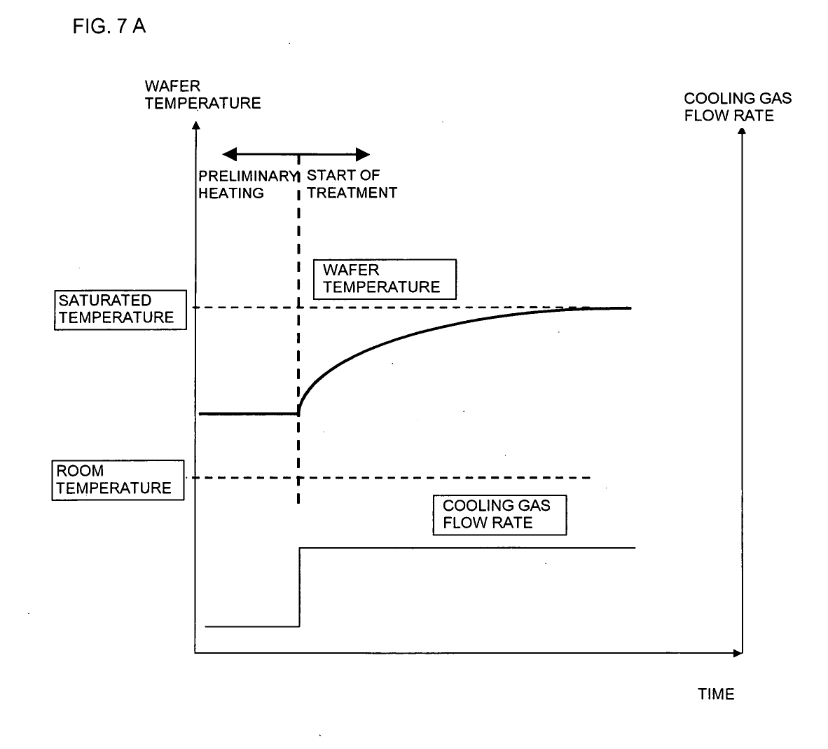

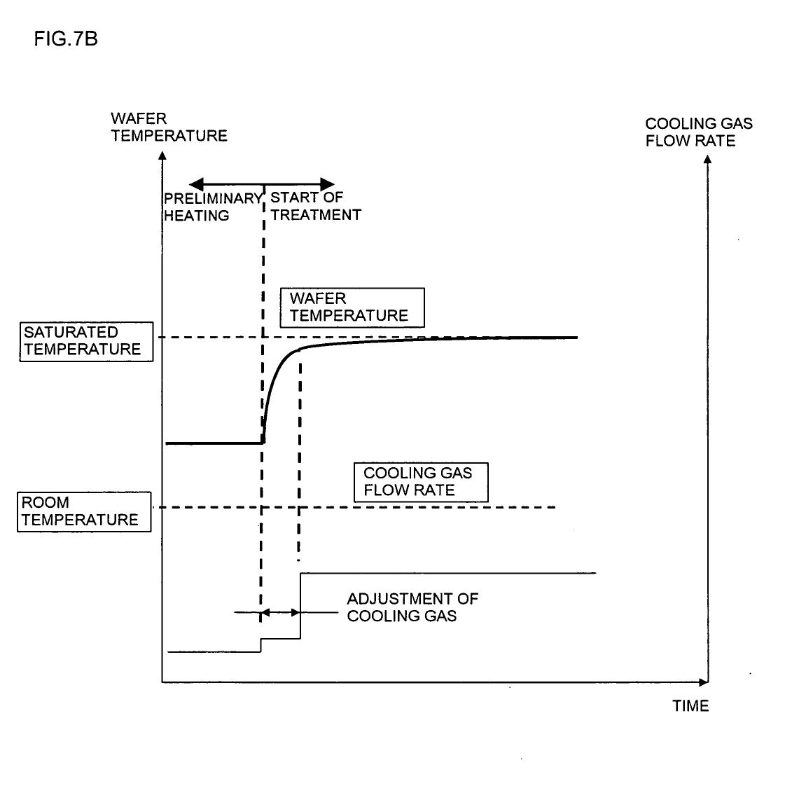

With reference to FIGS. 7A and 7B, a description will be given of Embodiment 5, which is such that the adjustment of the wafer temperature by the cooling gas, which was described in Embodiment 3, and the adjustment of the wafer temperature by preliminary heating, which was described in Embodiment 4, are used in combination.

FIGS. 7A and 7B give a comparison between a case where the adjustment of the cooling gas flow rate is performed and a case where the adjustment of the cooling gas flow rate is not performed. In both cases, the treatment is started before the saturated temperature of a wafer is reached although preliminary heating is used. FIG. 7A shows the case where the adjustment of the cooling gas flow rate is not performed, and FIG. 7B shows the case where the adjustment of the cooling gas flow rate is performed already at the start of the treatment. When the adjustment of the cooling gas flow rate is not performed, it takes time before the saturated temperature is reached because preliminary heating is insufficient. However, when the adjustment of the cooling gas flow rate is performed, the saturated temperature is rapidly reached and it becomes possible to suppress the adhesion and deposition of excessive deposits and to shorten the preliminary heating time.

On the basis of the above-described embodiments, as a technique for adjusting the wafer temperature, it is possible to adopt either of the method which involves the adjustment of the cooling gas supply pressure and the method which involves the adjustment of the cooling gas flow rate.

According to the present invention, it is possible to improve the processing performance of semiconductors.

What is claimed is:

1. An etching treatment method which is performed, by use of an etching apparatus which has a vacuum chamber which is evacuated to produce a vacuum by vacuum evacuation means, etching gas introducing means for introducing an etching gas into the vacuum chamber, means for setting a sample to be worked which is provided within the vacuum chamber and sets the sample to be worked, cooling gas introducing means which supplies a cooling gas to a back surface of the sample to be worked, a high frequency power source of high frequency electromagnetic waves supplied into the vacuum chamber, a matching device, power introducing means which introduces high frequency power into the vacuum chamber, and a high frequency bias power source which applies a high frequency bias voltage to the sample to be worked, by converting a gas introduced into the vacuum chamber by the etching gas introducing means into a plasma by high frequency power which is introduced by use of the power introducing means and applying high frequency bias power to the sample to be worked, whereby surface treatment of the sample to be worked is performed by the plasma,
wherein in treating the sample to be worked by use of a highly depositable gas, the temperature of the sample to be worked at the start of the treatment is maintained at a desired level.

2. The etching treatment method according to claim 1, wherein etching treatment is performed by continuing an electric discharge between steps.

3. The etching treatment method according to claim 1, wherein in subjecting the sample to be worked to etching treatment sequentially under multiple treatment conditions, with an electric discharge for plasma generation continued and also with application of high frequency bias power to the sample continued, a transition is made from each treatment condition to a succeeding treatment condition.

4. The etching treatment method according to claim 1, wherein in subjecting the sample to be worked to etching treatment sequentially under multiple treatment conditions, with an electric discharge for plasma generation continued and also with application of high frequency bias power to the sample continued, a transition is made from each treatment condition to a succeeding treatment condition, and during the transition of the conditions, a matching device of the high frequency power source makes a shift to a matching position in which input power and reflection power of high frequency power which have been determined beforehand obtain a prescribed ratio.

5. The etching treatment method according to claim 1, wherein formation and adhesion of deposits are controlled by controlling a sample temperature.

6. The etching treatment method according to claim 1, wherein in subjecting the sample to be worked to etching treatment sequentially under multiple treatment conditions, an electric discharge for plasma generation between treatment steps is continued so that among multiple treatment steps, a wafer temperature in an initial period of a succeeding step does not drop lower than a temperature during treatment in a preceding step.

7. The etching treatment method according to claim 1, wherein so that a desired temperature of a sample to be treated is obtained, the pressure or flow rate and time of a cooling gas which is filled in between the sample to be worked and an electrode on which the sample to be worked is set are controlled.

8. The etching treatment method according to claim 1, wherein before a prescribed treatment is performed after the sample to be worked is carried into the vacuum chamber, the sample to be worked is preliminarily heated.
